(19) United States
(12) Patent Application Publication
(10) Pub. No.: US 2025/0159651 A1
(43) Pub. Date: May 15, 2025

(54) SYSTEMS AND METHODS FOR ENHANCING GEOLOCATION DATA FOR OPTIMAL SERVING LOCATION SELECTION IN WIRELESS NETWORKS

(71) Applicant: Verizon Patent and Licensing Inc., Basking Ridge, NJ (US)

(72) Inventors: Krzysztof PAWLIKOWSKI, Farmington, CT (US); Khurram ABBAS, Novi, MI (US)

(73) Assignee: Verizon Patent and Licensing Inc., Basking Ridge, NJ (US)

(21) Appl. No.: 18/508,465

(22) Filed: Nov. 14, 2023

(51) Int. Cl. H04W 64/00; H04W 24/02; H04W 88/18

(52) U.S. Cl. CPC H04W 64/003; H04W 24/02; H04W 88/18

(57) ABSTRACT

A device may receive, from a service provider, a network address associated with a request for a service. The request for the service may be provided to the service provider by a user equipment associated with a network device. The device may receive, from the service provider, a query for a geolocation of the network device, and may determine the geolocation of the network device based on the network address. The device may provide the geolocation of the network device to the service provider.

### BACKGROUND

There exists a general need to geolocate users based on public network address (e.g., Internet protocol (IP) address) allocation. Multiple geolocation providers exist to provide a service that attempts to match a physical location (e.g., a geolocation) of a user equipment (UE) assigned to a specific IP address.

### BRIEF DESCRIPTION OF THE DRAWINGS

FIGS. 1A-1E are diagrams of an example associated with enhancing geolocation data for optimal serving location selection in wireless networks.

FIG. 2 is a diagram of an example environment in which systems and/or methods described herein may be implemented.

FIG. 3 is a diagram of example components of one or more devices of FIG. 2.

FIG. 4 is a flowchart of an example process for enhancing geolocation data for optimal serving location selection in wireless networks.

### DETAILED DESCRIPTION OF EXAMPLE EMBODIMENTS

The following detailed description of example implementations refers to the accompanying drawings. The same reference numbers in different drawings may identify the same or similar elements.

Various methods are used by geolocation providers to determine geolocations of user equipments (UEs) (e.g., users), such as gathering latitude and longitude information from UEs on a periodic basis, consuming geographical feeds, ingesting regional Internet registry information data, and/or the like. All of these methods attempt to tie a specific IP address to a location closest to an actual UE assigned the Internet protocol (IP) address. Optimal resource selection is the process of assigning a resource (e.g., a server device) closest to a UE requesting a service and ideally resulting in a lowest latency possible. For example, the optimal resource selection process may assign a resource in a data center located on the west coast to a UE located in Arizona (e.g., based on the IP address of the UE), rather than assigning a resource in a data center located on the east coast.

As stated previously, geolocation providers attempt to provide a physical location of a UE associated with a specific IP address and without the use of global positioning system (GPS) information of the UE. However, relying on the physical location of the UE fails to guarantee optimal resource selection in wireless networks (e.g., fourth generation (4G) networks, fifth generation (5G) networks, and/or the like). Wireless network providers typically assign IP addresses dynamically based on a pool of available IP addresses tied to a network device (e.g., a gateway router, such as a packet data network gateway (PGW) in a 4G network or a user plane function (UPF) in a 5G network) that serves a broad geographic area. Each time a UE attaches to the network, a new IP address is assigned to the UE and it is not guaranteed that the UE will be assigned the same IP address the next time the UE attaches to the network.

Thus, current techniques for providing optimal resource selection consume computing resources (e.g., processing resources, memory resources, communication resources, and/or the like), networking resources, and/or other resources associated with assigning a non-optimal resource for a UE based on the geolocation of the UE, providing a poor user experience for the UE assigned to the non-optimal resource, causing network congestion, higher service latency, and network throughput issues based on assigning the non-optimal resource for the UE, and/or the like.

Some implementations described herein provide a location system that enhances geolocation data for optimal serving location selection in wireless networks. For example, a service provider may receive a request for a service from a UE associated with a network device, and may extract a network address associated with the request. The location system may receive, from the service provider, the network address associated with the request and a query for a geolocation of the network device. The location system may determine the geolocation of the network device based on the network address, and may provide the geolocation of the network device to the service provider. The service provider may extract the network address from the request for the service, and may assign a closest serving location for the service to the UE based on the geolocation of the network device. The service provider may cause the service to be provided to the UE via the closest serving location.

In this way, the location system enhances geolocation data for optimal serving location selection in wireless networks. For example, the location system may provide a network device (e.g., a gateway) location service using network application programming interfaces (APIs). The location system may provide a service that utilizes a network address to identify a geolocation of a network device. The service may be available to geolocation providers to resolve a network address space to a specific geolocation of the network device. The location system may map a network address to a network device and may return geolocation information for the network device. Thus, the location system may conserve computing resources, networking resources, and/or other resources that would have otherwise been consumed by assigning a non-optimal resource for a UE based on the geolocation of the UE, providing a poor user experience for the UE assigned to the non-optimal resource, causing network congestion, higher service latency, and network throughput issues based on assigning the non-optimal resource for the UE, and/or the like.

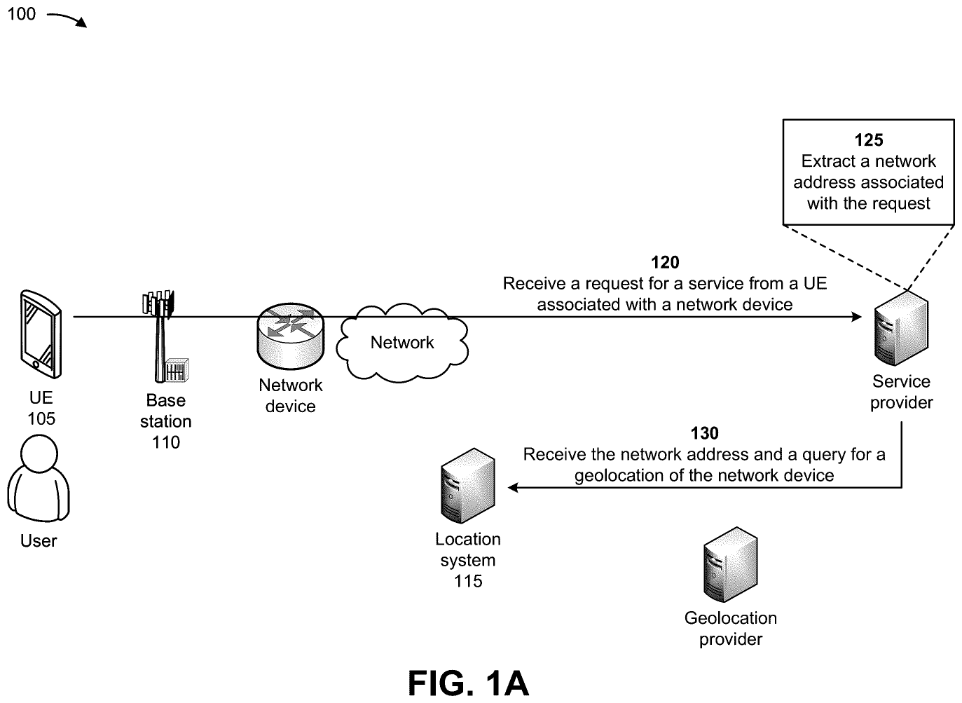

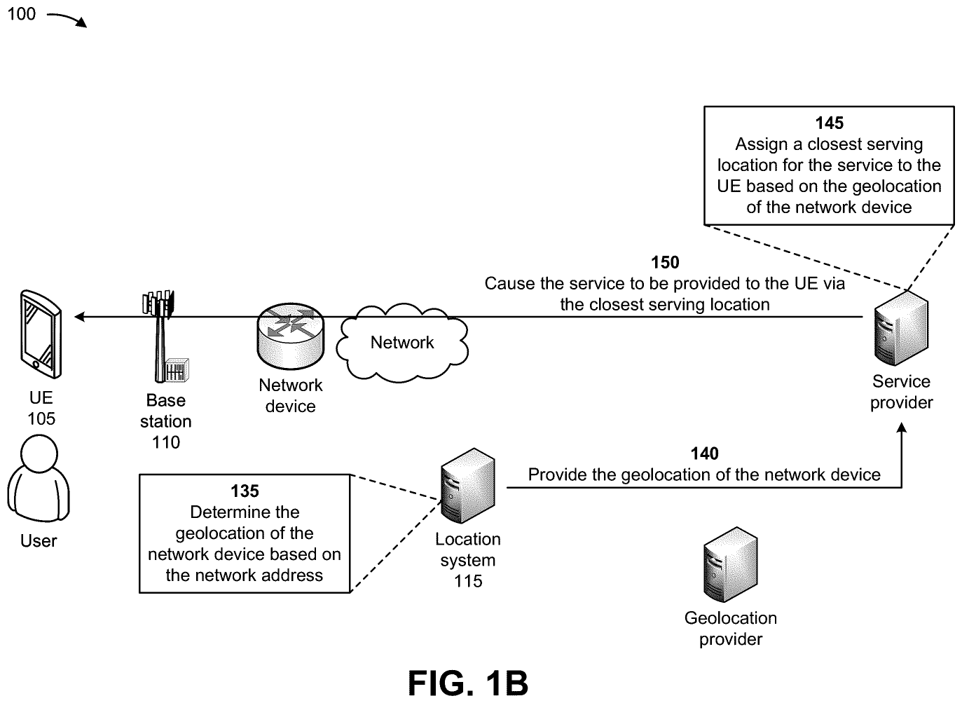

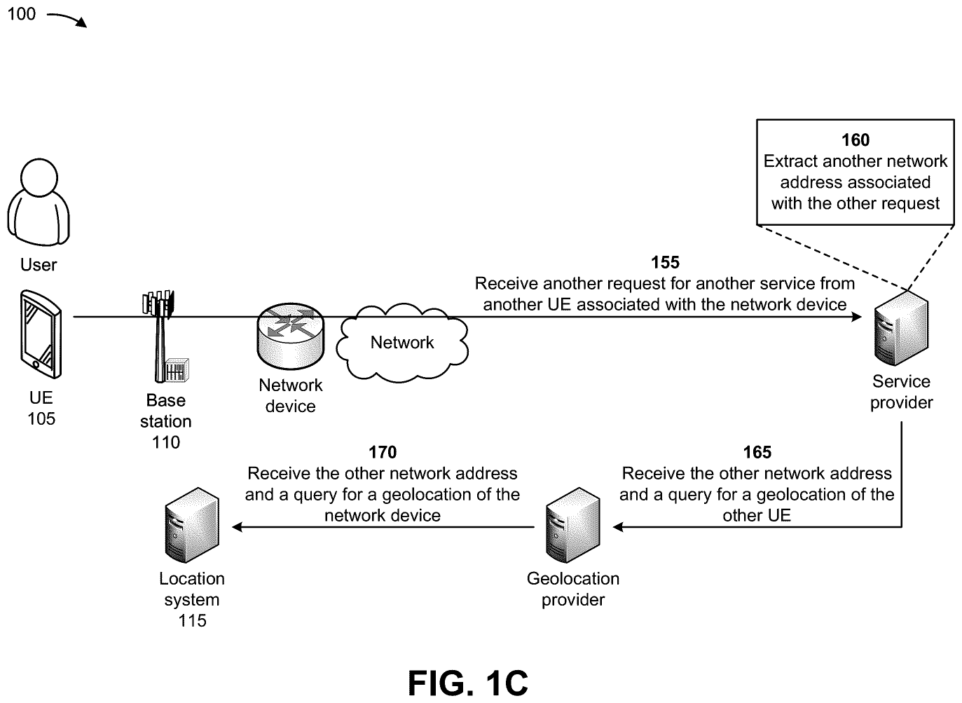

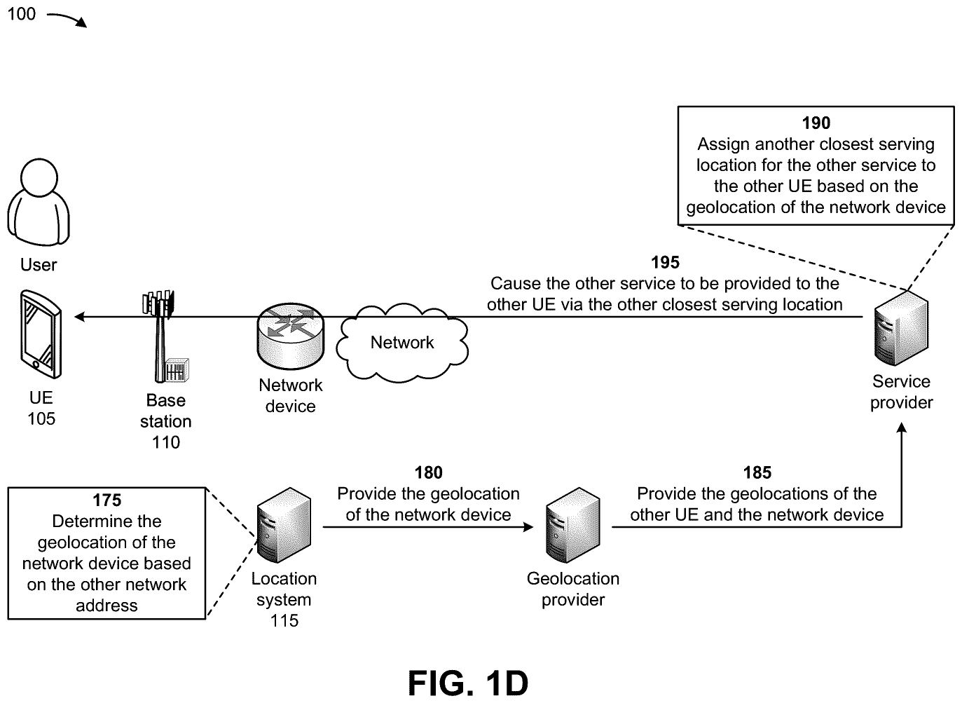

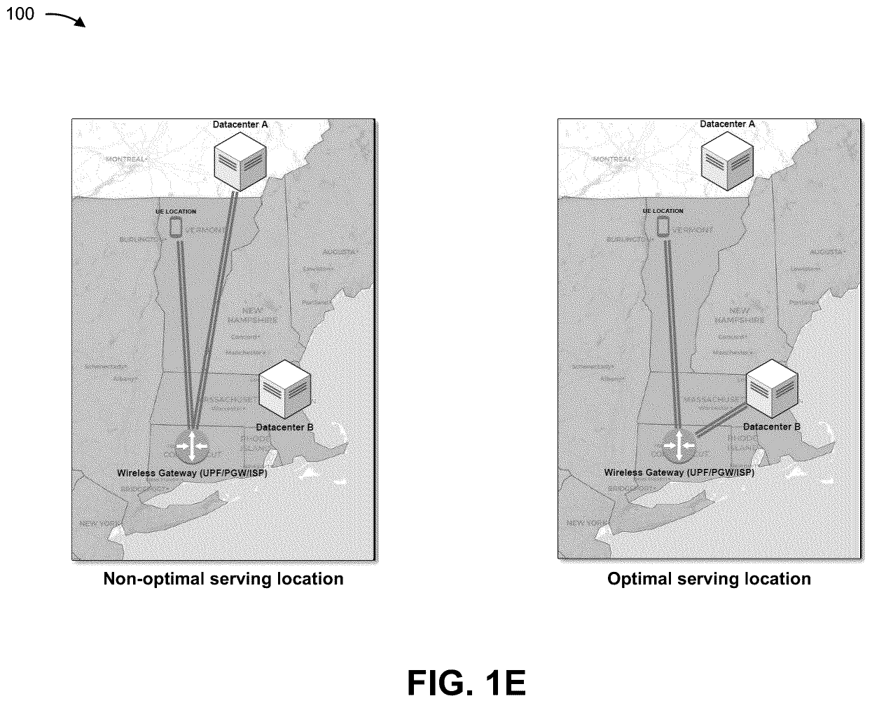

FIGS. 1A-1E are diagrams of an example 100 associated with enhancing geolocation data for optimal serving location selection in wireless networks. As shown in FIGS. 1A-1E, the example 100 includes a UE 105 associated with a user, a base station 110, a network device of a network, a service provider, geolocation provider, and a location system 115. In some implementations, the network device may be a PGW when the network is a 4G network. In some implementations, the network device may be a UPF when the network is a 5G network. Further details of the UE 105, the base station 110, the network device, the network, the service provider, the geolocation provider, and the location system 115 are provided elsewhere herein.

As shown in FIG. 1A, and by reference number 120, the service provider may receive a request for a service from the UE 105 associated with the network device. For example, a user of the UE 105 may cause the UE 105 to generate a request for a service offered by the service providers. The service may include a streaming service, a gaming service, a content service, and/or the like, and the request for the service may include a request for streaming data, a request for gaming data, a request for content, and/or the like. The UE 105 may be dynamically assigned a network address (e.g., an IP version 4 (IPv4) address or an IP version 6 (IPv6) address), from a pool of network addresses associated with the network device, so that the UE 105 may communicate with the service provider via the network. The UE 105 may provide the request for the service to the base station 110, and the base station 110 may provide the request for the service to the network device. The network device may utilize the network address assigned to the UE 105 to provide the request for the service to the service provider, via the network. The service provider may receive the request for the service from the network.

As further shown in FIG. 1A, and by reference number 125, the service provider may extract a network address associated with the request. For example, since the network device utilizes the network address assigned to the UE 105 to provide the request for the service to the service provider (e.g., via the network), the request for the service may be associated with the network address. Thus, the service provider may analyze the request for the service, and may extract the network address assigned to the UE 105 from the request for the service based on analyzing the request for the service.

As further shown in FIG. 1A, and by reference number 130, the location system 115 may receive the network address and a query for a geolocation of the network device. For example, the service provider may query the geolocation of the network device from the location system 115, as described below in connection with FIGS. 1A and 1B. Alternatively, the service may query the geolocation of the network device from a geolocation provider that queries the geolocation of the network device from the location system 115, as described below in connection with FIGS. 1C and 1D. In some implementations, the service provider may provide the network address assigned to the UE 105 and the query for the geolocation of the network device directly to the location system 115. In such implementations, the location system 115 may receive the network address and the query for the geolocation of the network device from the service provider.

As shown in FIG. 1B, and by reference number 135, the location system 115 may determine the geolocation of the network device based on the network address. For example, the location system 115 may communicate with the network device to receive the pool of network addresses associated with the network device and dynamically assigned by the network device to one or more UEs 105. The location system 115 may also receive, from the network, geolocations of all network devices associated with the network. In some implementations, when determining the geolocation of the network device based on the network address, the location system 115 may map the network address to one of the pool network addresses associated with the network device in order to identify the network device associated with the network address. Once the network device is identified, the location system 115 may determine the geolocation of the network device based on identifying the geolocation of the network device in the geolocations of all network devices associated with and received from the network.

As further shown in FIG. 1B, and by reference number 140, the location system 115 may provide the geolocation of the network device to the service provider. For example, in response to the query for the geolocation of the network device, the location system 115 may provide the geolocation of the network device to the service provider. The service provider may receive the geolocation of the network device from the location system 115.

As further shown in FIG. 1B, and by reference number 145, the service provider may assign a closest serving location for the service to the UE 105 based on the geolocation of the network device. For example, the service provider may compare the geolocation of the network device with serving locations for the service (e.g., locations of resources, such as servers, that are capable of providing the service to the UE 105), and may identify, from the serving locations, the closest serving location for the service to the UE 105 based on comparing the geolocation of the network device with the serving locations for the service. In some implementations, the closest serving location may include a location of a resource for the service that is physically closest to the geolocation of the network device. In some implementations, the closest serving location may be capable of providing streaming data, gaming data, content, and/or the like to the UE 105.

As further shown in FIG. 1B, and by reference number 150, the service provider may cause the service to be provided to the UE 105 via the closest serving location. For example, the service provider may instruct the closest serving location (e.g., the closest resource for the service) to provide the service to the UE 105, which may reduce latency and provide a better user experience for the UE 105. The closest serving location may provide the service to the UE 105 based on being instructed by the service provider to provide the service to the UE 105. The UE 105 may receive the service from the closest serving location and may provide the service to the user of the UE 105.

As shown in FIG. 1C, and by reference number 155, the service provider may receive another request for another service from another UE 105 associated with the network device. For example, another user of another UE 105, different than the UE 105 may cause the other UE 105 to generate another request for another service offered by the service providers. The other service may include a streaming service, a gaming service, a content service, and/or the like, and the other request for the other service may include a request for streaming data, a request for gaming data, a request for content, and/or the like. The other UE 105 may be dynamically assigned another network address (e.g., an IPv4 address or an IPv6 address), from the pool of network addresses associated with the network device, so that the other UE 105 may communicate with the service provider via the network. The other UE 105 may provide the other request for the other service to the base station 110, and the base station 110 may provide the other request for the other service to the network device. The network device may utilize the other network address assigned to the other UE 105 to provide the other request for the other service to the service provider, via the network. The service provider may receive the other request for the other service from the network.

As further shown in FIG. 1C, and by reference number 160, the service provider may extract another network address associated with the other request. For example, since the network device utilizes the other network address assigned to the other UE 105 to provide the other request for the other service to the service provider (e.g., via the network), the other request for the other service may be associated with the other network address. Thus, the service provider may analyze the other request for the other service, and may extract the other network address assigned to the other UE 105 from the other request for the other service based on analyzing the other request for the other service.

As further shown in FIG. 1C, and by reference number 165, the geolocation provider may receive the other network address and a query for a geolocation of the other UE 105. For example, instead of providing the other network address directly to the location system 115 (e.g., as described above in connection with FIG. 1A), the service provider may provide the other network address assigned to the other UE 105 and a query for a geolocation of the other UE 105 to the geolocation provider. In some implementations, the geolocation provider may receive the other network address and the query for the geolocation of the other UE 105 from the service provider.

As further shown in FIG. 1C, and by reference number 170, the location system 115 may receive the other network address and a query for a geolocation of the network device. For example, the geolocation provider may provide the other network address assigned to the other UE 105 and the query for the geolocation of the network device to the location system 115. In some implementations, the location system 115 may receive the other network address and the query for the geolocation of the network device from the geolocation provider.

As shown in FIG. 1D, and by reference number 175, the location system 115 may determine the geolocation of the network device based on the other network address. For example, the location system 115 may communicate with the network device to receive the pool of network addresses associated with the network device and dynamically assigned by the network device to one or more UEs 105. The location system 115 may also receive, from the network, geolocations of all network devices associated with the network. In some implementations, when determining the geolocation of the network device based on the other network address, the location system 115 may map the other network address to one of the pool network addresses associated with the network device in order to identify the network device associated with the other network address. Once the network device is identified, the location system 115 may determine the geolocation of the network device based on identifying the geolocation of the network device in the geolocations of all network devices associated with and received from the network.

As further shown in FIG. 1D, and by reference number 180, the location system 115 may provide the geolocation of the network device. For example, in response to the query for the geolocation of the network device, the location system 115 may provide the geolocation of the network device to the geolocation provider. The geolocation provider may receive the geolocation of the network device from the location system 115.

As further shown in FIG. 1D, and by reference number 185, the geolocation provider may provide the geolocations of the other UE 105 and the network device. For example, in response to the query for the geolocation of the other UE 105, the geolocation provider may determine the geolocation of the other UE 105 based geographical location information received from the other UE 105. The geolocation provider may provide the geolocation of the other UE 105 and the geolocation of the network device to the service provider. The service provider may receive the geolocation of the other UE 105 and the geolocation of the network device from the geolocation provider.

As further shown in FIG. 1D, and by reference number 190, the service provider may assign another closest serving location for the other service to the other UE 105 based on the geolocation of the network device. For example, the service provider may compare the geolocation of the network device with serving locations for the other service (e.g., locations of resources, such as servers, that are capable of providing the other service to the other UE 105), and may identify, from the serving locations, the other closest serving location for the other service to the other UE 105 based on comparing the geolocation of the network device with the serving locations for the other service. In some implementations, the other closest serving location may include a location of a resource for the other service that is physically closest to the geolocation of the network device. In some implementations, the closest serving location may be capable of providing streaming data, gaming data, content, and/or the like to the other UE 105.

As further shown in FIG. 1D, and by reference number 195, the service provider may cause the other service to be provided to the other UE 105 via the other closest serving location. For example, the service provider may instruct the other closest serving location (e.g., the closest resource for the other service) to provide the other service to the other UE 105, which may reduce latency and provide a better user experience for the other UE 105. The other closest serving location may provide the other service to the other UE 105 based on being instructed by the service provider to provide the other service to the other UE 105. The other UE 105 may receive the other service from the other closest serving location and may provide the other service to the other user of the other UE 105.

A left image of FIG. 1E depicts selection of a non-optimal serving location when the location system 115 is not utilized. For example, a single wireless gateway (e.g., a PGW or a UPF) may serve a geographic area (in lighter grey) and IP addresses assigned to each UE 105 may be recycled at any time throughout the geographic area served by the gateway. This illustrates a location of the UE 105 alone cannot guarantee optimal serving location selection. The single gateway may serve a broad geographic area and the UE 105 may connect to the gateway which assigns a publicly routable IP address to the UE 105. If a service (e.g., an application) is hosted in both data center A and data center B and solely relies on the location of the UE 105 provided by a geolocation provider, the UE 105 would be assigned a non-optimal serving location (e.g., data center A) since traffic for the service must flow through the gateway in order to reach data center A (e.g., when data center B is closer to the gateway). A right image of FIG. 1E depicts selection of an optimal serving location when the location system 115 is utilized. In an optimal routing scenario, data center B may be selected by the service (e.g., an application) in order to reduce latency experienced by the UE 105 since data center B is closer to the gateway.

In this way, the location system 115 enhances geolocation data for optimal serving location selection in wireless networks. For example, the location system 115 may provide a network device (e.g., a gateway) location service using network APIs. The location system 115 may provide a service that utilizes a network address to identify a geolocation of a network device. The service may be available to geolocation providers to resolve a network address space to a specific geolocation of the network device. The location system 115 may map a network address to a network device and may return geolocation information for the network device. Thus, the location system 115 may conserve computing resources, networking resources, and/or other resources that would have otherwise been consumed by assigning a non-optimal resource for a UE 105 based on the geolocation of the UE 105, providing a poor user experience for the UE 105 assigned to the non-optimal resource, causing network congestion, higher service latency, and network throughput issues based on assigning the non-optimal resource for the UE 105, and/or the like.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

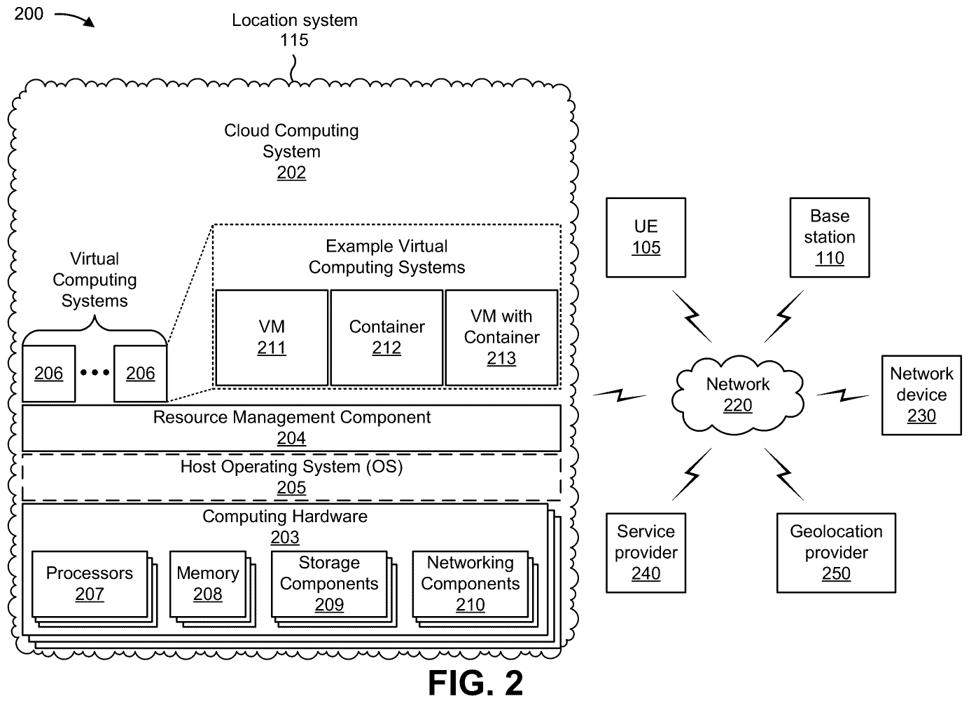

FIG. 2 is a diagram of an example environment 200 in which systems and/or methods described herein may be implemented. As shown in FIG. 2, the environment 200 may include the location system 115, which may include one or more elements of and/or may execute within a cloud computing system 202. The cloud computing system 202 may include one or more elements 203-213, as described in more detail below. As further shown in FIG. 2, the environment 200 may include the UE 105, the base station 110, a network 220, a network device 230, a service provider 240, and/or a geolocation provider 250. Devices and/or elements of the environment 200 may interconnect via wired connections and/or wireless connections.

The UE 105 may include one or more devices capable of receiving, generating, storing, processing, and/or providing information, as described elsewhere herein. The UE 105 may include a communication device and/or a computing device. For example, the UE 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The base station 110 includes one or more devices capable of transferring traffic, such as audio, video, text, and/or other traffic, destined for and/or received from a user equipment. For example, the base station 110 may include an eNodeB (eNB) associated with a long term evolution (LTE) network that receives traffic from and/or sends traffic to a core network, a gNodeB (gNB) associated with a RAN of a 5G network, a base transceiver station, a radio base station, a base station subsystem, a cellular site, a cellular tower, an access point, a transmit receive point (TRP), a radio access node, a macrocell base station, a microcell base station, a picocell base station, a femtocell base station, and/or another network entity capable of supporting wireless communication. The base station 110 may support, for example, a cellular radio access technology (RAT). The base station 110 may transfer traffic between a user equipment (e.g., using a cellular RAT), one or more other base stations 110 (e.g., using a wireless interface or a backhaul interface, such as a wired backhaul interface), and/or a core network. The base station 110 may provide one or more cells that cover geographic areas.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

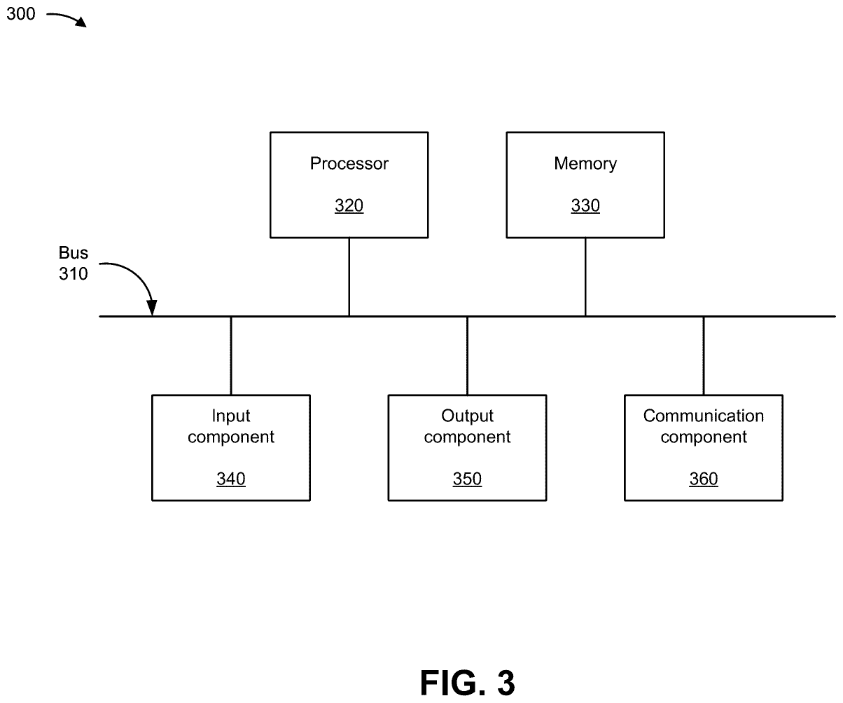

Although the location system 115 may include one or more elements 203-213 of the cloud computing system 202, may execute within the cloud computing system 202, and/or may be hosted within the cloud computing system 202, in some implementations, the location system 115 may not be cloud-based (e.g., may be implemented outside of a cloud computing system) or may be partially cloud-based. For example, the location system 115 may include one or more devices that are not part of the cloud computing system 202, such as the device 300 of FIG. 3, which may include a standalone server or another type of computing device. The location system 115 may perform one or more operations and/or processes described in more detail elsewhere herein.

The network 220 may include one or more wired and/or wireless networks. For example, the network 220 may include a cellular network (e.g., a 5G network, a 4G network, an LTE network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 220 enables communication among the devices of the environment 200.

The network device 230 may include one or more devices capable of receiving, processing, storing, routing, and/or providing traffic (e.g., a packet and/or other information or metadata) in a manner described herein. For example, the network device 230 may include a router, such as a label switching router (LSR), a label edge router (LER), an ingress router, an egress router, a provider router (e.g., a provider edge router or a provider core router), a virtual router, or another type of router. Additionally, or alternatively, the network device 230 may include a gateway, a switch, a firewall, a hub, a bridge, a reverse proxy, a server (e.g., a proxy server, a cloud server, or a data center server), a load balancer, and/or a similar device. In some implementations, the network device 230 may be a physical device implemented within a housing, such as a chassis. In some implementations, the network device 230 may be a virtual device implemented by one or more computing devices of a cloud computing environment or a data center. In some implementations, a group of network devices 230 may be a group of data center nodes that are used to route traffic flow through a network. In some implementations, the network device 230 may be a PGW when the network 220 is a 4G network, a UPF when the network 220 is a 5G network, and/or the like.

The service provider 240 may include one or more devices capable of receiving, generating, storing, processing, providing, and/or routing information, as described elsewhere herein. The service provider 240 may include a communication device and/or a computing device. For example, the service provider 240 may include a server, such as an application server, a client server, a web server, a database server, a host server, a proxy server, a virtual server (e.g., executing on computing hardware), or a server in a cloud computing system. In some implementations, the service provider 240 may include computing hardware used in a cloud computing environment.

The geolocation provider 250 may include one or more devices capable of receiving, generating, storing, processing, providing, and/or routing information, as described elsewhere herein. The geolocation provider 250 may include a communication device and/or a computing device. For example, the geolocation provider 250 may include a server, such as an application server, a client server, a web server, a database server, a host server, a proxy server, a virtual server (e.g., executing on computing hardware), or a server in a cloud computing system. In some implementations, the geolocation provider 250 may include computing hardware used in a cloud computing environment.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the UE 105, the base station 110, the location system 115, the network device 230, the service provider 240, and/or the geolocation provider 250. In some implementations, the UE 105, the base station 110, the location system 115, the network device 230, the service provider 240, and/or the geolocation provider 250 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

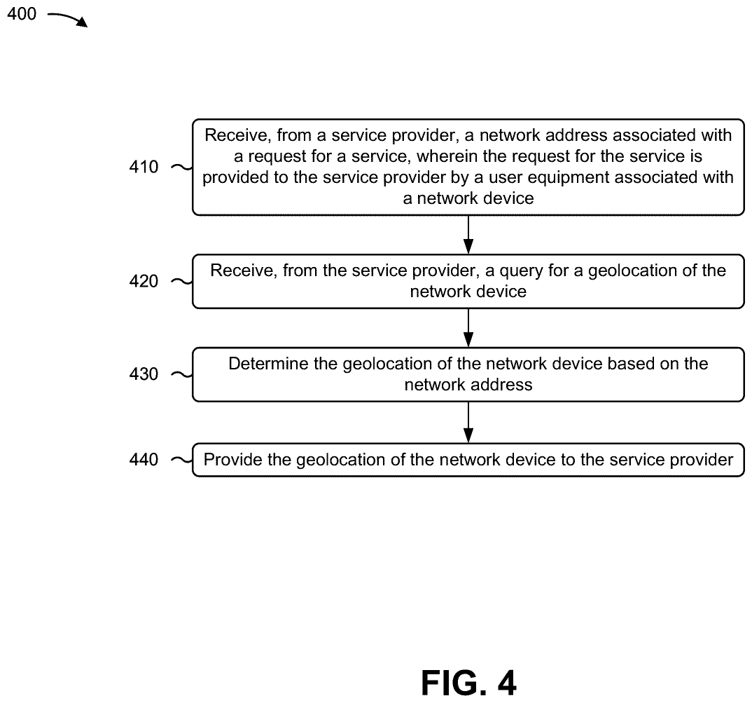

FIG. 4 is a flowchart of an example process 400 for enhancing geolocation data for optimal serving location selection in wireless networks. In some implementations, one or more process blocks of FIG. 4 may be performed by a device (e.g., the location system 115). In some implementations, one or more process blocks of FIG. 4 may be performed by another device or a group of devices separate from or including the device, such as a UE (e.g., the UE 105), a base station (e.g., the base station 110), and/or the like. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving, from a service provider, a network address associated with a request for a service, wherein the request for the service is provided to the service provider by a UE associated with a network device (block 410). For example, the device may receive, from a service provider, a network address associated with a request for a service, as described above. In some implementations, the request for the service is provided to the service provider by a UE associated with a network device. In some implementations, the service provider is configured to extract the network address from the request for the service. In some implementations, the network device is a PGW of a 4G network. In some implementations, the network device is a UPF of a 5G network. In some implementations, the request for the service is a request for content. In some implementations, the UE is associated with a 4G network or a 5G network.

As further shown in FIG. 4, process 400 may include receiving, from the service provider, a query for a geolocation of the network device (block 420). For example, the device may receive, from the service provider, a query for a geolocation of the network device, as described above.

As further shown in FIG. 4, process 400 may include determining the geolocation of the network device based on the network address (block 430). For example, the device may determine the geolocation of the network device based on the network address, as described above. In some implementations, determining the geolocation of the network device based on the network address includes mapping the network address to the network device, and determining the geolocation of the network device based on mapping the network address to the network device.

As further shown in FIG. 4, process 400 may include providing the geolocation of the network device to the service provider (block 440). For example, the device may provide the geolocation of the network device to the service provider, as described above. In some implementations, the service provider is configured to assign a closest serving location for the service to the UE based on the geolocation of the network device. In some implementations, the service provider is configured to cause the service to be provided to the UE via the closest serving location.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

In some implementations, process 400 includes receiving another network address associated with another request for another service, wherein the other request for the other service is provided to the service provider by another UE associated with another network device, and the other network address is received from a geolocation provider; receiving a query for a geolocation of the other network device from the geolocation provider; determining the geolocation of the other network device based on the other network address; and providing the geolocation of the other network device to the geolocation provider. In some implementations, the geolocation provider is configured to provide the geolocation of the other UE and the geolocation of the other network device to the service provider. In some implementations, the service provider is configured to assign another closest serving location for the other service to the other UE based on the geolocation of the other network device. In some implementations, the service provider is configured to cause the other service to be provided to the other UE via the other closest serving location.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device and from a service provider, a network address associated with a request for a service,
wherein the request for the service is provided to the service provider by a user equipment associated with a network device;
receiving, by the device and from the service provider, a query for a geolocation of the network device;
determining, by the device, the geolocation of the network device based on the network address; and
providing, by the device, the geolocation of the network device to the service provider.

2. The method of claim 1, wherein the service provider extracts the network address from the request for the service.

3. The method of claim 1, wherein the service provider assigns a closest serving location for the service to the user equipment based on the geolocation of the network device.

4. The method of claim 3, wherein the service provider is configured to cause the service to be provided to the user equipment via the closest serving location.

5. The method of claim 1, wherein determining the geolocation of the network device based on the network address comprises:
mapping the network address to the network device; and
determining the geolocation of the network device based on mapping the network address to the network device.

6. The method of claim 1, wherein the network device is a packet data network gateway of a fourth generation network.

7. The method of claim 1, wherein the network device is a user plane function of a fifth generation network.

8. A device, comprising:
one or more processors configured to:
receive, from a service provider, a network address associated with a request for a service,
wherein the request for the service is provided to the service provider by a user equipment associated with a network device;
receive, from the service provider, a query for a geolocation of the network device;
determine the geolocation of the network device based on the network address; and
provide the geolocation of the network device to the service provider to cause the service provider to assign a closest serving location for the service to the user equipment based on the geolocation of the network device.

9. The device of claim 8, wherein the one or more processors are further configured to:
receive another network address associated with another request for another service,
wherein the other request for the other service is provided to the service provider by another user equipment associated with another network device,
wherein the other network address is received from a geolocation provider,
receive a query for a geolocation of the other network device from the geolocation provider;
determine the geolocation of the other network device based on the other network address; and
provide the geolocation of the other network device to the geolocation provider.

10. The device of claim 9, wherein the geolocation provider, provides the geolocation of the other user equipment and the geolocation of the other network device to the service provider.

11. The device of claim 9, wherein the service provider is configured to assign another closest serving location for the other service to the other user equipment based on the geolocation of the other network device.

12. The device of claim 11, wherein the service provider is configured to cause the other service to be provided to the other user equipment via the other closest serving location.

13. The device of claim 8, wherein the request for the service is a request for content.

14. The device of claim 8, wherein the user equipment is associated with a fourth generation network or a fifth generation network.

15. A non-transitory computer-readable medium storing a set of instructions, the set of instructions comprising:
one or more instructions that, when executed by one or more processors of a device, cause the device to:
receive, from a service provider, a network address associated with a request for a service,
wherein the request for the service is provided to the service provider by a user equipment associated with a network device;
receive, from the service provider, a query for a geolocation of the network device;
determine the geolocation of the network device based on the network address; and
provide the geolocation of the network device to the service provider.

16. The non-transitory computer-readable medium of claim 15, wherein the service provider is configured to extract the network address from the request for the service.

17. The non-transitory computer-readable medium of claim 15, wherein the service provider is configured to assign a closest serving location for the service to the user equipment based on the geolocation of the network device.

18. The non-transitory computer-readable medium of claim 17, wherein the service provider is configured to cause the service to be provided to the user equipment via the closest serving location.

19. The non-transitory computer-readable medium of claim 15, wherein the one or more instructions, that cause the device to determine the geolocation of the network device based on the network address, cause the device to:
map the network address to the network device; and
determine the geolocation of the network device based on mapping the network address to the network device.

20. The non-transitory computer-readable medium of claim 15, wherein the network device is one of a packet data network gateway of a fourth generation network or a user plane function of a fifth generation network.
